(19) United States
(12) Patent Application Publication
(10) Pub. No.: US 2006/0234231 A1
(43) Pub. Date: Oct. 19, 2006

(54) Microarrays displaying encoded molecules

(75) Inventors: Per-Ola Freskgard, Vellinge (SE); Henrik Pedersen, Bagsvaerd (DK)

Correspondence Address: BROWDY AND NEIMARK, P.L.L.C.;624 NINTH STREET, NW, SUITE 300, WASHINGTON, DC, 20001-5303, US

(73) Assignee: Nuevolution A/S, Copenhagen (DE)

(21) Appl. No.: 10/518,056

(22) PCT Filed: Jun. 20, 2003
(86) PCT No.: PCT/DK03/00417

§ 371 Date: Oct. 3, 2005

Related U.S. Application Data
(63) Continuation-in-part of application No. 10/175,539, filed on Jun. 20, 2002.
(60) Provisional application No. 60/299,443, filed on Jun. 21, 2001.
(60) Provisional application No. 60/364,056, filed on Mar. 15, 2002.

(30) Foreign Application Priority Data
Jun. 20, 2001 (DK) PA 2001 00962

(51) Int. Cl. C40B 30/04; C40B 40/08

(52) U.S. Cl. 435/6; 435/287.2

(57) ABSTRACT

Disclosed is a microarray comprising a plurality of single stranded nucleic acid probes immobilized in discrete areas of a solid support, said probes being hybridised to a library of complexes, wherein each complex comprises an encoded molecule and a template which codes for said molecule, said template comprising a number of codons which codes for chemical entities which upon reaction form a reaction product which at least partly form part of the encoded molecule.

### TECHNICAL FIELD OF THE INVENTION

The present invention relates to an oligonucleotide microarray which has been annealed to a complex so as to present at spatially defined spots encoded molecules.

### BACKGROUND

Microarrays have found a wide acceptance in various analysis concepts. Microarrays can be used to profile gene patterns yielding information on the genotype of an individual. Information on the expression of the genes may be accomplished using messenger RNA (mRNA) samples in order to obtain knowledge on a disease state, hormone action, infection etc. The presence or absence of a particular SNP may also be verified using Microarrays.

In U.S. Pat. No. 60,207,446 B1 it has been suggested to use a microarray to present polypeptides linked to the mRNA which is responsible for the formation thereof. The mRNA-protein fusion is formed by allowing a ribosome to translate an mRNA provided at the 3′ end with puromycin and linking the formed protein to said mRNA at the termination of the translation. By annealing a mixture of RNA-protein fusions to a microarray it is possible to display the proteins. As spots on the microarray comprise different sequences of nucleotides and the RNA sequences anneal sequence specifically to the probes, the proteins are presented at spatial defined areas of the microarray.

The prior art is restricted to the presenting of proteins on a microarray. According to an object of the present invention it is desired to expand the type of molecules which can be presented on a microarray. In one aspect of the invention, it is small molecules which are presented and in another aspect it is unnatural polymers that are presented. Notably, the present invention is not limited to the reaction products of the 20 naturally occurring amino acids, which allow for a higher diversity of the presented molecule and the possibility of forming robust and stable molecules that can be treated under harsh conditions, such as high temperature, extreme pH and in media containing detergents.

### SUMMARY OF THE INVENTION

The present invention relates to microarray comprising a plurality of single stranded nucleic acid probes immobilized in discrete areas of a solid support, said probes being hybridised to a library of complexes, wherein each complex comprises an encoded molecule and a template which codes for said molecule, said template comprising a number of codons which codes for chemical entities which upon reaction form a reaction product which at least partly form part of the encoded molecule.

The term microarray generally refers to an ordered array of microscopic elements on a planar substrate. Commercially available standard oligonucleotide microarrays may be used to prepare the microarray of the invention. Suitably, an oligonucleotide microarray is a device having a plurality of different single stranded oligonucleotide probes immobilized in discrete areas of a solid support. The discrete areas comprising immobilized single-stranded oligonucleotides may be referred to as spots for short.

The oligonucleotides immobilised in the spots may comprise any oligomer of nucleotides known in the art and in particular the nucleotides described below. Preferred oligonucleotides are capable of forming a specific hybridisation with a complementing oligonucleotide.

The solid support is preferable dimensional to add precision to the manufacturing and detection steps. Any specific dimension of the spotting area may be used. To adapt to the scanners usually used in the art, the solid support is usually of the dimension of a traditional 1×3-in microscope slide. The solid support is preferable flat, that is, the solid support has even parallel surfaces over a local region. The solid support should be uniform in the sense that irregularities preferably are avoid in the bulk of the support as well as in the surface coating or treatment. Preferably, the solid support is durable, i.e. a processed microarray should loose less than 10% of the annealed oligonucleotides over the assay duration, and inert, i.e. the solid support does not contribute any gain or loss of signal in the detection step. Usually, the solid support is a glass plate, a silicon or silicon-glass plate (e.g. a microchip), or a polymer plate.

Each spot on the solid support comprises the same nucleic acid probe, while at least one other spot comprises a different nucleic acid probe. The distance between each immobilized oligonucleotide on the spot is suitably 10 to 100 Å, and preferably between 10 and 50 Å to allow for optimized reaction kinetics and readily detection. The centre-to-centre spacing of the spots is suitable constant and in the range from 20 μm to 1000 μm and more preferred between 50 μm and 500 μm.

The oligonucleotides immobilized on the solid support can be prepared in any convenient way. Usually, either a delivery approach or a synthesis approach is used. According to the delivery approach the oligonucleotides are synthesised, e.g. using the phosphoramidate method, and subsequent printed on the solid support, where the oligonucleotides are immobilized. The immobilization of preformed oligonucleotides may be performed utilizing any of a variety of attachment chemistries, such as (i) the formation of aminosilanes on a glass support and attaching the oligonucleotides thereto, (ii) the formation of an aldehyde surface on the solid support and reacting with an oligonucleotide comprising an amine, typically an aliphatic amine linker to form a covalent attachment, and (iii) the covalent attachment of an oligonucleotide carrying an anthraquinone to a polymer solid support as disclosed in WO 01/04129. The synthesis approach employs in situ synthesis of the oligonucleotides on the solid support using repeated addition of nucleotides until the final oligonucleotide eventually is formed. Usually, a method employing photo activation and masking is used.

Each of the complexes hybridised to the microarray comprises an encoded molecule and a template which codes for the encoded molecule. Usually, the template comprises a nucleic acid, such as an oligonucleotide. The oligonucleotide can contain any of the nucleotides mentioned below.

It is preferred that the template is divided into coding regions or codons which codes for specific chemical entities. A codon is a sequence of nucleotides or a single nucleotide. The nucleotides are usually amplifiable and the nucleobases are selected from the natural nucleobases (adenine, guanine, uracil, thymine, and cytosine) and the backbone is selected from DNA and RNA, preferably DNA.

The codon may be a single nucleotide. In the generation of a library, this will allow for the incorporation of four different chemical entities into the encoded molecule. However, to obtain a higher diversity a codon in certain embodiments preferably comprises at least two and more preferred at least three nucleotides. Theoretically, this will provide for 4² and 4³, respectively, different chemical entities. The codons will usually not comprise more than 100 nucleotides. It is preferred to have codons with a sequence of 3 to 30 nucleotides.

The template will in general have at least two codons, which are arranged in sequence, i.e. next to each other. Each of the codons may be separated by a spacer group. Depending on the encoded molecule formed, the template may comprise further codons, such as 3, 4, 5, or more codons. Each of the further codons may be separated by a suitable spacer group. Preferably, all or at least a majority of the codons of the template are arranged in sequence and each of the codons is separated from a neighbouring codon by a spacer group. Alternatively, codons on the template may be designed with overlapping sequences.

Generally, it is preferred to have more than two codons on the template to allow for the synthesis of more diverse template-directed molecules. In a preferred aspect of the invention the number of codons of the template is 2 to 100. Still more preferred is templates comprising 3 to 20 codons.

The spacer sequence may serve various purposes. In one setup of the invention, the spacer group identifies the position of a codon. Usually, the spacer group either upstream or downstream of a codon comprises information which allows determination of the position of the codon. The spacer group may also or in addition provide for a region of high affinity. The high affinity region will ensure that the hybridisation of the template with the anti-codon will occur in frame. Moreover, the spacer sequence may adjust the annealing temperature to a desired level.

A spacer sequence with high affinity can be provided by incorporation of one or more nucleobases forming three hydrogen bonds to a cognate nucleobase. An example of a nucleobase having this property is guanine. Alternatively, or in addition, the spacer sequence may be subjected to back bone modification. Several back bone modifications provides for higher affinity, such as 2′-O-methyl substitution of the ribose moiety, peptide nucleic acids (PNA), and 2′-4′ O-methylene cyclisation of the ribose moiety, also referred to as LNA (Locked Nucleic Acid).

The template may comprise flanking regions. The flanking region can encompasses a signal group, such a flourophor or a radio active group, to allow a direct detection of the presence of the complex. The flanking regions can also serve as priming sites for an amplification reaction, such as PCR. The template may in certain embodiments comprise an affinity region having the property of being able to hybridise to a building block.

It is to be understood that when the term template is used in the present description and claims, the template may be in the sense or the anti-sense format, i.e. the template part of the complex can be a sequence of codons which actually codes for the molecule or can be a sequence complementary thereto.

The encoded molecule is formed by a variety of reactants which have reacted with each other and/or a scaffold molecule. Optionally, this reaction product may be post-modified to obtain the encoded molecule displayed on the microarray. The post-modification may involve the cleavage of one or more chemical bond attaching the encoded molecule to the template in order more efficiently to display the encoded molecule.

The formation of an encoded molecule generally starts by a scaffold, i.e. a chemical unit having one or more reactive groups capable of forming a connection to another reactive group positioned on a chemical entity, thereby generating an addition to the original scaffold. A second chemical entity may react with a reactive group also appearing on the original scaffold or a reactive group incorporated by the first chemical entity. Further chemical entities maybe involved in the formation of the final reaction product. The formation of a connection between the chemical entity and the nascent encoded molecule maybe be mediated by a bridging molecule. As an example, if the nascent encoded molecule and the chemical entity both comprises an amine group a connection between these can be mediated by a dicarboxylic acid.

The encoded molecule may be attached directly the template or through a suitable linking moiety. Furthermore, the encoded molecule may be linked to the template through a cleavable linker to release the encoded molecule at a point in time selected by the experimenter.

The chemical entities that are precursors for structural additions or eliminations of the encoded molecule may be attached to a building block prior to the participation in the formation of the reaction product leading the final encoded molecule. Besides the chemical entity, the building block generally comprises an anti-codon. In some embodiment the building block also comprise an affinity region providing for affinity towards the nascent complex.

Thus, the chemical entities are suitably mediated to the nascent encoded molecule by a building block, which further comprises an anticodon. The anti-codon serves the function of transferring the genetic information of the building block in conjunction with the transfer of a chemical entity. The transfer of genetic information and chemical entity may occur in any order, however, it is important that a correspondence is maintained in the complex. The chemical entities are preferably reacted without enzymatic interaction. Notably, the reaction of the chemical entities is preferably not mediated by ribosomes or enzymes having similar activity. The chemical entities may be reacted with each other or a scaffold having a recipient reactive group.

According to certain aspects of the invention the genetic information of the anti-codon is transferred by specific hybridisation to a codon on the template. Other methods for transferring the genetic information of the anti-codon to the nascent complex are to anneal an oligonucleotide complementary to the anti-codon and attach this oligonucleotide to the complex, e.g. by ligation. A still further method involves transferring the genetic information of the anti-codon to the nascent complex using a polymerase and a mixture of dNTPs.

The chemical entity of the building block serves the function of being a precursor for the structural entity eventually incorporated into the encoded molecule. Therefore, when it in the present application with claims is stated that a chemical entity is transferred to a nascent encoded molecule it is to be understood that not necessarily all the atoms of the original chemical entity is to be found in the eventually formed encoded molecule. Also, as a consequence of the reactions involved in the connection, the structure of the chemical entity can be changed when it appears on the nascent encoded molecule. Especially, the cleavage resulting in the release of the entity may generate a reactive group which in a subsequent step can participate in the formation of a connection between a nascent complex and a chemical entity.

The chemical entity of the building block comprises at least one reactive group capable of participating in a reaction which results in a connection between the chemical entity of the building block and another chemical entity or a scaffold associated with the nascent complex. The connection is facilitated by one or more reactive groups of the chemical entity. The number of reactive groups which appear on the chemical entity is suitably one to ten. A building block featuring only one reactive group is used i.a. in the end positions of polymers or scaffolds, whereas building blocks having two reactive groups are suitable for the formation of the body part of a polymer or scaffolds capable of being reacted further. One, two or more reactive groups intended for the formation of connections, are typically present on scaffolds. A scaffold is a core structure, which forms the basis for the creation of multiple variants. The variant forms of the scaffold are typically formed through reaction of reactive groups of the scaffold with reactive groups of other building blocks, optionally mediated by fill-in groups or catalysts, under the creation of a connection between the entities. The chemical entities to be connected to the scaffold may contain one, two or several reactive groups able to form connections.

The reactive group of the building block may be capable of forming a direct connection to a reactive group of the nascent complex or the reactive group of the building block may be capable of forming a connection to a reactive group of the nascent complex through a bridging fill-in group. It is to be understood that not all the atoms of a reactive group are necessarily maintained in the connection formed. Rather, the reactive groups are to be regarded as precursors for the structure of the connection. FIG. 5 shows examples of various reactive groups and the corresponding connection formed.

The subsequent cleavage step to release the chemical entity from the building block can be performed in any appropriate way. In an aspect of the invention the cleavage involves usage of a reagent or and enzyme. The cleavage results in a transfer of the chemical entity to the nascent encoded molecule or in a transfer of the nascent encoded molecule to the chemical entity of the building block. In some cases it may be advantageous to introduce new chemical groups as a consequence of linker cleavage. The new chemical groups may be used for further reaction in a subsequent cycle, either directly or after having been activated. In other cases it is desirable that no trace of the linker remains after the cleavage. FIG. 6 shows examples of conditions for linkers between the building block and the chemical entity to be cleaved.

In another aspect, the connection and the cleavage is conducted as a simultaneous reaction, i.e. either the chemical entity of the building block or the nascent encoded molecule is a leaving group of the reaction. In general, it is preferred to design the system such that the connection and the cleavage occur simultaneously because this will reduce the number of steps and the complexity. The simultaneous connection and cleavage can also be designed such that either no trace of the linker remains or such that a new chemical group for further reaction is introduced, as described above. In FIG. 4 exemplary reactive groups leading to transfer of a chemical entity to the entities harbouring one of the reactive groups are shown.

It is important for the method according to the invention that at least one linkage remains intact between the encoded molecule and the template. In case the method essentially involves the transfer of chemical entities to a scaffold or an evolving polymer, the eventually scaffolded molecule or the polymer may be attached with a selectively cleavable linker. The selectively cleavable linker is designed such that it is not cleaved under conditions which result in a transfer of the chemical entity to the nascent encoded molecule.

The attachment of the chemical entity can be at any entity available for attachment, e.g. the chemical entity can be attached to a nucleobase or the back bone. In general, it is preferred to attach the chemical entity at the phosphor of the internucleoside linkage or at the nucleobase. When the nucleobase is used for attachment of the chemical entity, the attachment point is usually at the 7 position of the purines or 7-deaza-purins or at the 5 position of pyrimidines. The nucleotide may be distanced from the reactive group of the chemical entity by a spacer moiety. The spacer may be designed such that the conformational spaced sampled by the reactive group is optimized for a reaction with the reactive group of the nascent encoded molecule.

The design of building blocks comprising the anti-codon may be aimed at obtaining annealing temperatures in a specific range for all or some of the building block: template hybrids to ensure that the anti-codons have been annealed to the template before the chemical entities are connected to each other through a chemical reaction.

The templates are preferably designed to have an annealing temperature within a certain range to obtain a condition at which all or at least the majority of complexes can be annealed to the probes of the array through the templates.

The complexes for the library can be prepared in accordance with a variety of methods. Examples of these methods are depicted below and generally described in PCT/DK 02/00419.

A first embodiment is based on the use of a polymerase to incorporate unnatural nucleotides as building blocks. Initially, a plurality of template oligonucleotides are provided. Subsequently a primer is annealed to the each template and a polymerase is extending the primer using nucleotide derivatives which have appended chemical entities. Subsequent to or simultaneously with the incorporation of the nucleotide derivatives, the chemical entities are reacted to form a reaction product.

Several possible reaction approaches for the chemical entities are apparent. First, the nucleotide derivatives can be incorporated and subsequently polymerised. In the event the chemical entities each carry two reactive groups, the chemical entities can be attached to adjacent chemical entities by a reaction of these reactive groups. Exemplary of the reactive groups are amine and carboxylic acid, which upon reaction form an amide bond. Adjacent chemical entities can also be linked together using a linking or bridging moiety. Exemplary of this approach is the linking of two chemical entities each bearing an amine group by a bi-carboxylic acid. Yet another approach is the use of a reactive group between a chemical entity and the nucleotide building block, such an ester or a thioester group. An adjacent building block having a reactive group such as an amine may cleave the interspaced reactive group to obtain a linkage to the chemical entity, e.g. by an amide linking group.

A second embodiment for obtainment of complexes pertains to the use of hybridisation of building blocks to a template and reaction of chemical entities attached to the building blocks in order to obtain a reaction product. This approach comprises that a plurality of templates are contacted with a plurality of building blocks, wherein each building block comprises an anti-codon and a chemical entity. The anti-codons are designed to have a recognition sequence, i.e. a codon, on the template. Subsequent to the annealing of the anti-codons and the codons to each other a reaction of the chemical entities are effected to obtain a reaction product.

The template may be associated with a scaffold. Building blocks bringing chemical entities in may be added sequentially or simultaneously and a reaction of the reactive group of the chemical entity may be effected at any time after the annealing of the building blocks to the template.

A third embodiment for the generation of a complex includes chemical or enzymatical ligation of building blocks when these are lined up on a template. Initially a plurality of templates are provided, each having one or more codons. The templates are contacted with building blocks comprising anti-codons linked to chemical entities. The two or more anti-codons annealed on a template are subsequently ligated to each other and a reaction of the chemical entities is effected to obtain a reaction product.

A fourth embodiment makes use of the extension by a polymerase of an affinity sequence of the nascent complex to transfer the anti-codon of a building block to the nascent complex. The method implies that a nascent complex comprising a scaffold and an affinity region, which may and may not contain coding regions. A building block comprising a region complementary to the affinity section is subsequently annealed to the nascent complex and the anti-codon region of the building block is transferred to the nascent complex by a polymerase. The transfer of the chemical entity may be transferred prior to, simultaneously with or subsequent to the transfer of the anti-codon.

After or simultaneously with the formation of the reaction product some of the linkers to the template may be cleaved, however at least one linker must be maintained to provide for the complex.

The library of the complexes may be added to the oligonucleotide microarray under hybridisation conditions in order for each template to anneal to a cognate probe on the microarray. The hybridisation conditions may be appropriately adjusted by a person skilled in the art taking into account the number and kind of nucleobases that participate in the formation of the hybrid.

It is within the capability of the skilled person in the art to construct the desired design of an oligonucleotide. When a specific annealing temperature is desired it is a standard procedure to suggest appropriate compositions of nucleic acid monomers and the length thereof. The construction of an appropriate design may be assisted by software, such as Vector NTI Suite or the public database at the internet address

http://www.nwfsc.noaa.gov/protocols/oligoTMcalc.html.

The conditions which allow specific hybridisation of the templates and probes are influenced by a number of factors including temperature, salt concentration, type of buffer, and acidity. It is within the capabilities of the person skilled in the art to select appropriate conditions to ensure that the contacting between the templates and the probes are performed at hybridisation conditions. The temperature at which two single stranded oligonucleotides forms a duplex is referred to as the annealing temperature or the melting temperature. The melting curve is usually not sharp indicating that the annealing occurs over a temperature range. The second derivative of the melting curve is used herein to indicate the annealing temperature.

The array according to the present invention may have many uses. One aspect of the present invention relates to methods for detecting the presence or absence of, and/or measuring the amount of target molecules in a sample, wherein the method employs complexes comprising encoded molecules, which is attached in an array system. The target molecule in the sample which has an affinity towards the encoded molecule immobilised on the microarray will bind to the encoded molecule this making the detection or measuring possible. In the event a variety of target molecules are present in the sample and a variety of encoded molecules are presented, multiple determinations are rendered possible.

The invention described herein provides arrays that can measure different amounts at the protein level without the use of proteins or peptides as detection molecules. The template-displaying molecule technology could be used to identify small molecules binding to numerous targets. These binding molecules could be arrayed in specific positions and work as detection molecules to measure the amount of various biomarkers. For example, binding molecule against cytokines or enzymes known to be involved in a specific pathway could be generated with the describe technology. These binding molecules could then be attached in an array format to be used to measure the absolute or relative amount of each cytokine or enzyme.

The template-encoded molecule complexes can be directly applied to a prespotted DNA and hybridised the probe, optionally using an adapter oligonucleotide, which is complementary to the probe as well as the template. Another possibility is that the synthesis could be performed directly on the precoated template using a polymerase and the nucleotide analogues. Making addressable microarrays with this technology will lead to high-throughput deposition of thousands of different functional molecules onto different locations of a chip. The overall principal is shown in FIG. 1.

Ordered display of encoded molecules is a powerful tool for the identification of previous unknown target-encoded molecule interaction. In one specific format, a target is detectably labelled, e.g. with a fluorescent dye, and incubated with a microarray displaying encoded molecules. By this approach, the identity of encoded molecules that are able to bind to a target molecule are determined from the location of the spots on the microarray that becomes labelled due to binding of the target. Related targets can be compared in order to identify molecules with high specificity for a specific subtype by analysis the binding pattern of these related targets on identical arrays of molecules. The above specific format may find application in the drug discovery process in which validated targets are used in order to identify suitable binding molecules.

Nucleotides

The nucleotides used in the present invention may be linked together in an oligonucleotide. Each nucleotide monomer is normally composed of two parts, namely a nucleobase moiety, and a backbone. The back bone may in some cases be subdivided into a sugar moiety and an internucleoside linker.

The nucleobase moiety may be selected among naturally occurring nucleobases as well as non-naturally occurring nucleobases. Thus, “nucleobase” includes not only the known purine and pyrimidine hetero-cycles, but also heterocyclic analogues and tautomers thereof. Illustrative examples of nucleobases are adenine, guanine, thymine, cytosine, uracil, purine, xanthine, diaminopurine, 8-oxo-N⁶-methyladenine, 7-deazaxanthine, 7-deazaguanine, N⁴,N⁴-ethanocytosin, N⁶,N⁶-ethano-2,6-diamino-purine, 5-methylcytosine, 5-(C³-C⁶)-alkynylcytosine, 5-fluorouracil, 5-bromouracil, pseudoisocytosine, 2-hydroxy-5-methyl-4-triazolopyridine, isocytosine, isoguanine, inosine and the “non-naturally occurring” nucleobases described in Benner et al., U.S. Pat. No. 5,432,272. The term “nucleobase” is intended to cover these examples as well as analogues and tautomers thereof. Especially interesting nucleobases are adenine, guanine, thymine, cytosine, 5-methylcytosine, and uracil, which are considered as the naturally occurring nucleobases in relation to therapeutic and diagnostic application in humans.

Examples of suitable specific pairs of nucleobases are shown below:

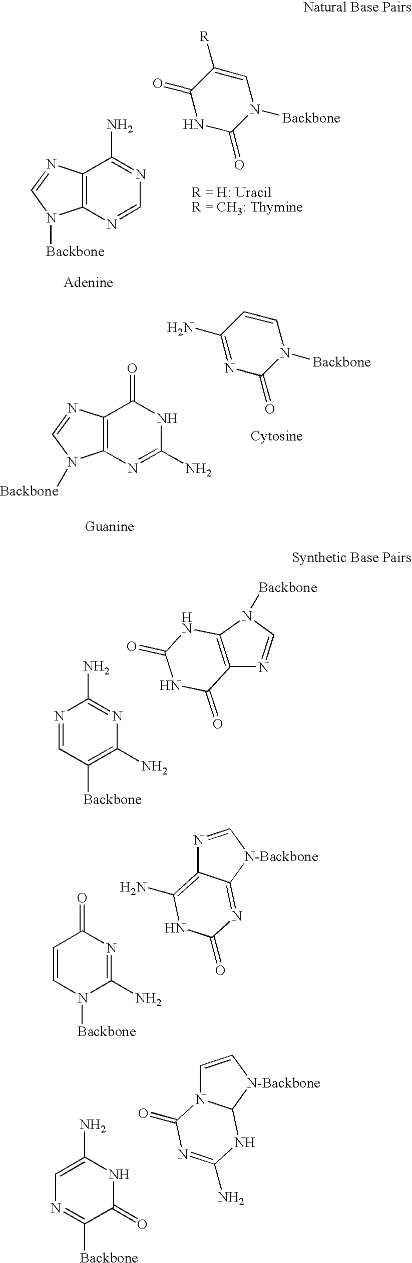

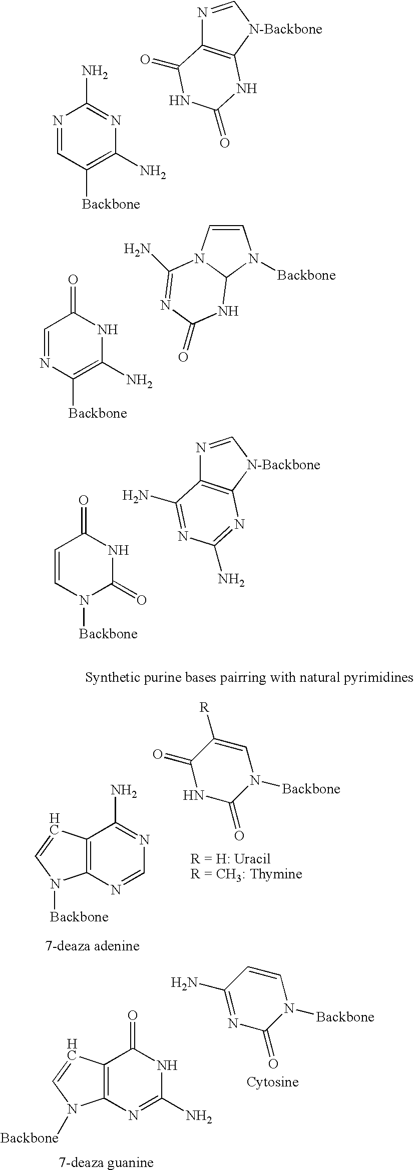

Suitable examples of backbone units are shown below (B denotes a nucleobase):

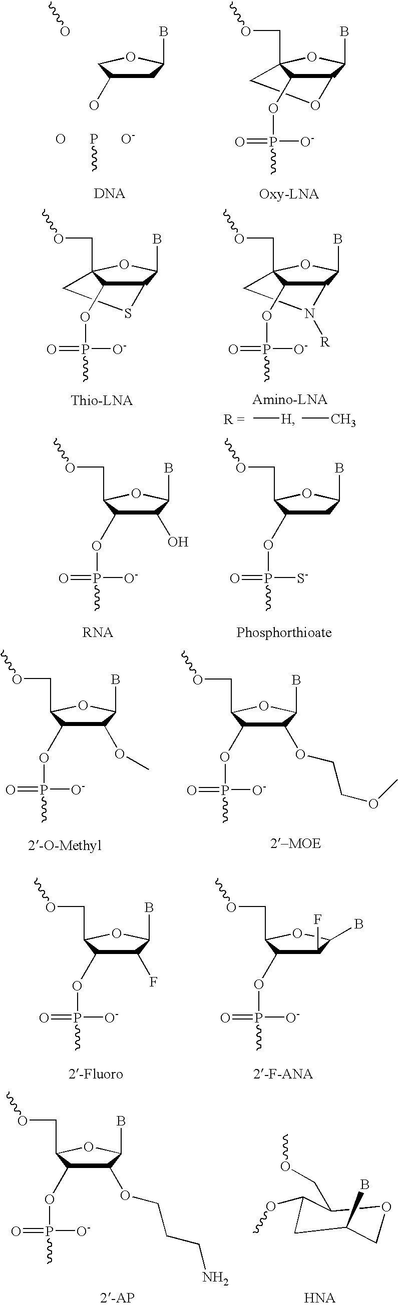

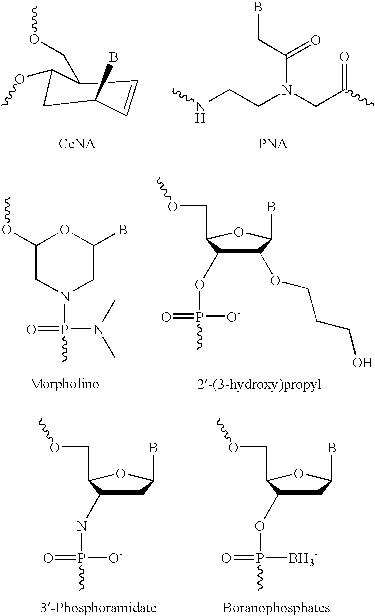

The sugar moiety of the backbone is suitably a pentose but may be the appropriate part of an PNA or a six-member ring. Suitable examples of possible pentoses include ribose, 2′-deoxyribose, 2′-O-methyl-ribose, 2′-flour-ribose, and 2′-4′-O-methylene-ribose (LNA). Suitably the nucleobase is attached to the 1′ position of the pentose entity.

An internucleoside linker connects the 3′ end of preceding monomer to a 5′ end of a succeeding monomer when the sugar moiety of the backbone is a pentose, like ribose or 2-deoxyribose. The internucleoside linkage may be the natural occurring phospodiester linkage or a derivative thereof. Examples of such derivatives include phosphorothioate, methylphosphonate, phosphoramidate, phosphotriester, and phosphodithioate. Furthermore, the internucleoside linker can be any of a number of non-phosphorous-containing linkers known in the art.

Preferred nucleic acid monomers include naturally occurring nucleosides forming part of the DNA as well as the RNA family connected through phosphodiester linkages. The members of the DNA family include deoxyadenosine, deoxyguanosine, deoxythymidine, and deoxycytidine. The members of the RNA family include adenosine, guanosine, uridine, cytidine, and inosine. Inosine is a non-specific pairing nucleoside and may be used as universal base as discussed above because inosine can pair nearly isoenergetically with A, T, and C.

### BRIEF DESCRIPTION OF THE FIGURES

FIG. 1 shows an array of displayed encoded molecules.

FIG. 2 shows the synthesis of an array of encoded molecules.

FIG. 3 shows the selection to obtain encoded molecules for array analysis

FIG. 4 shows reaction types allowing simultaneous reaction and cleavage, i.e. transfer of chemical entities to a nascent encoded molecule.

FIG. 5 shows pairs of reactive groups and the resulting bond.

FIG. 6 shows various cleavable chemical bonds, the products obtained and the agents necessary for the cleavage to occur.

### DETAILED DESCRIPTION OF THE FIGURES

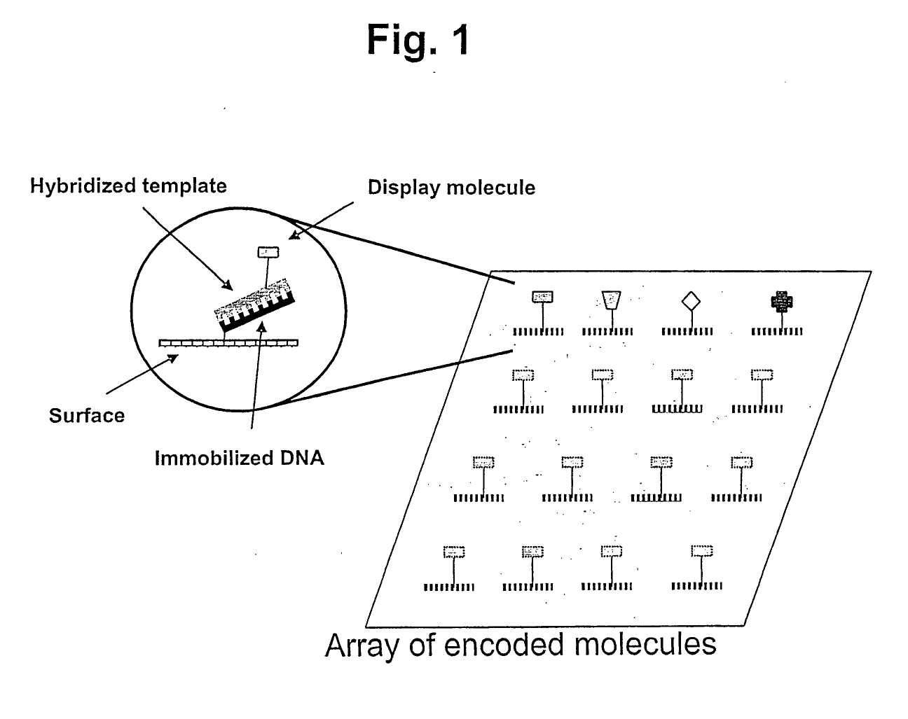

FIG. 1 shows an encoded molecule chip. A DNA library is spotted in array format on a suitable surface. A library of complexes comprising single-stranded template DNA is added and allowed to hybridise to the complement DNA strand. This allows site-specific immobilization of the encoded molecules. The site-specific immobilization is controlled by the codons of the complex.

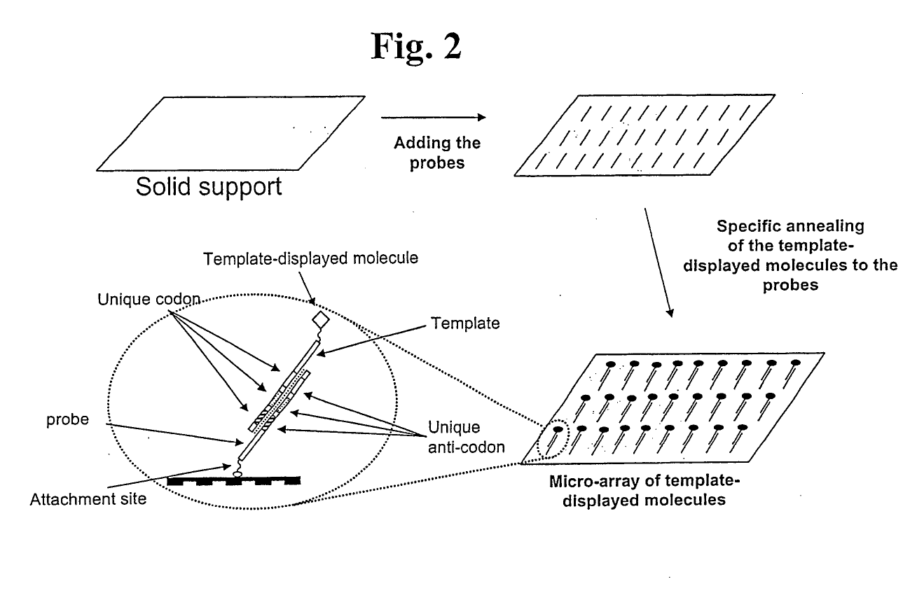

FIG. 2 shows the hybridization of encoded molecules mediated by the codon composition in each template molecule. According to a specific use, a biological sample containing target molecules is added and non-bound material is washed off. The final step is the detection of bound material in each single spot. In this example, the target molecule is labelled for detection.

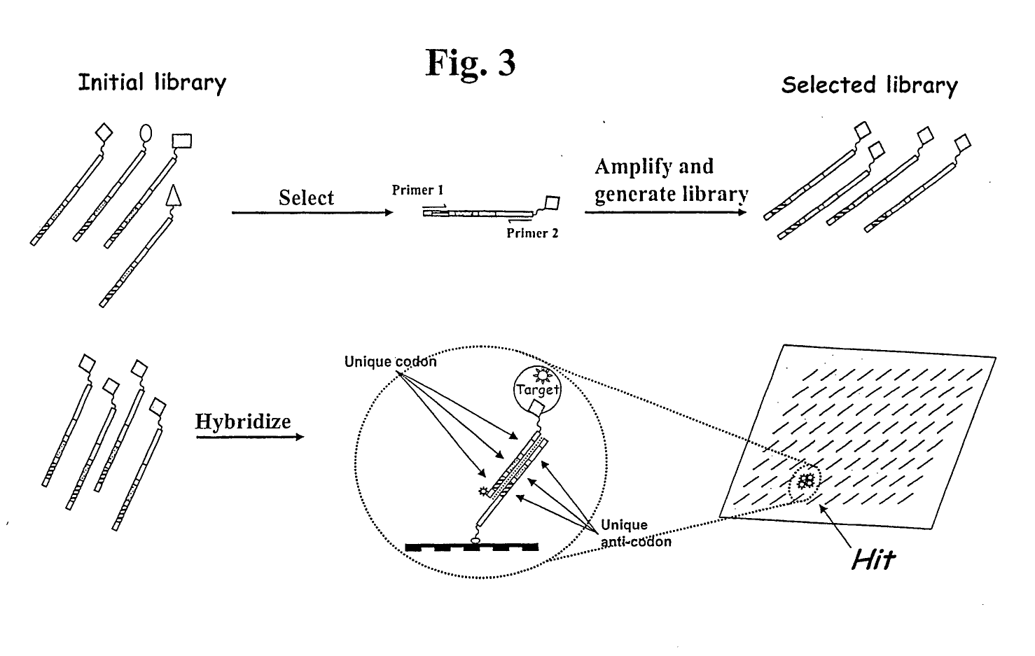

FIG. 3 shows the selection of an initial encoded library against a target. The enriched encoded molecules are hybridized on the array due the precise combination of codons in the template molecule. Finally, target molecule(s) are allowed to bind to the arrayed oligonucleotides and detected.

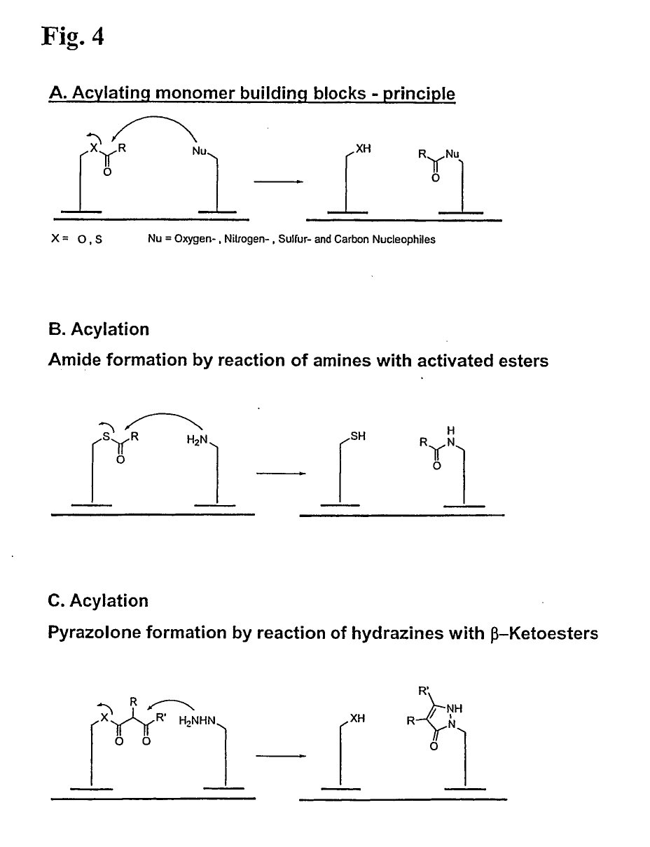

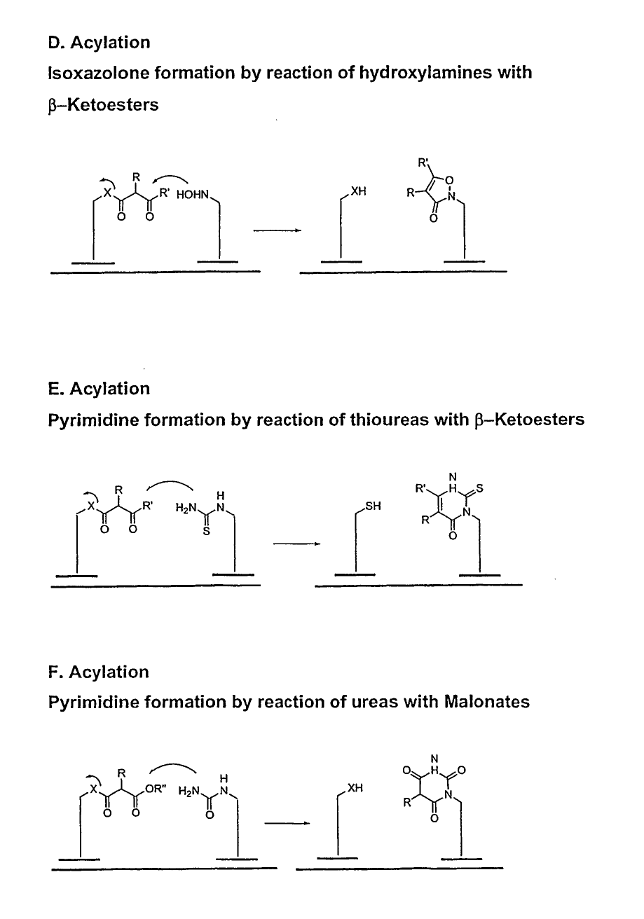

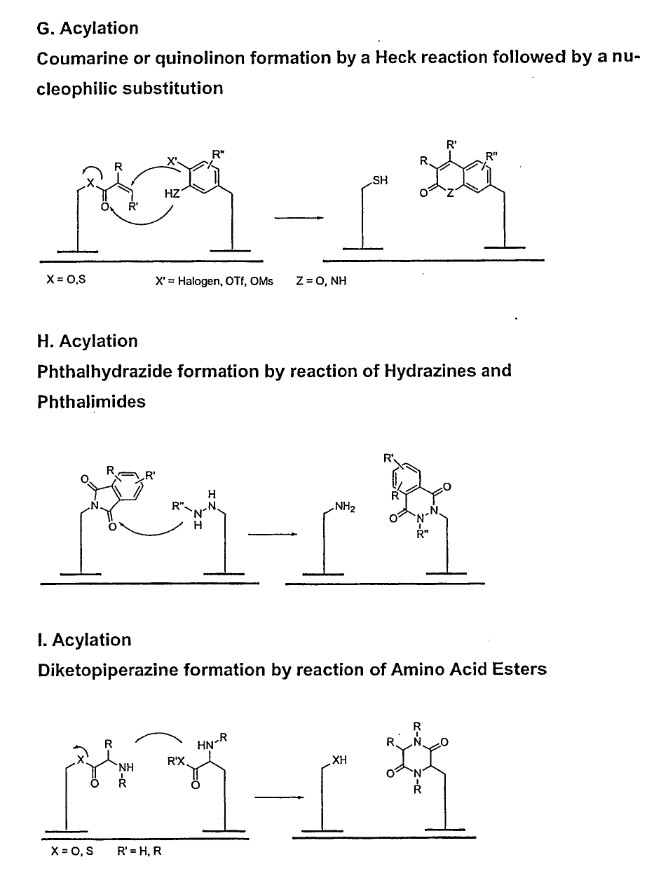

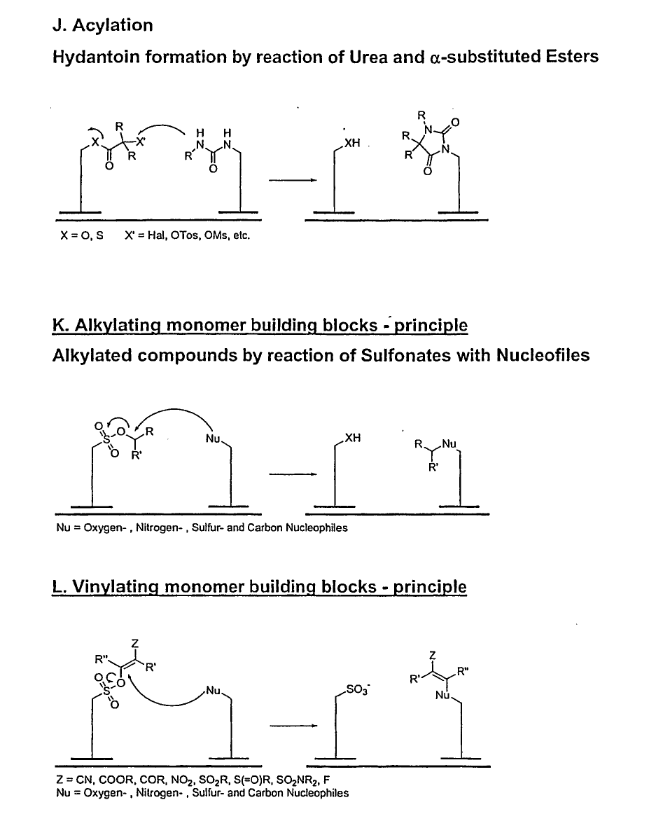

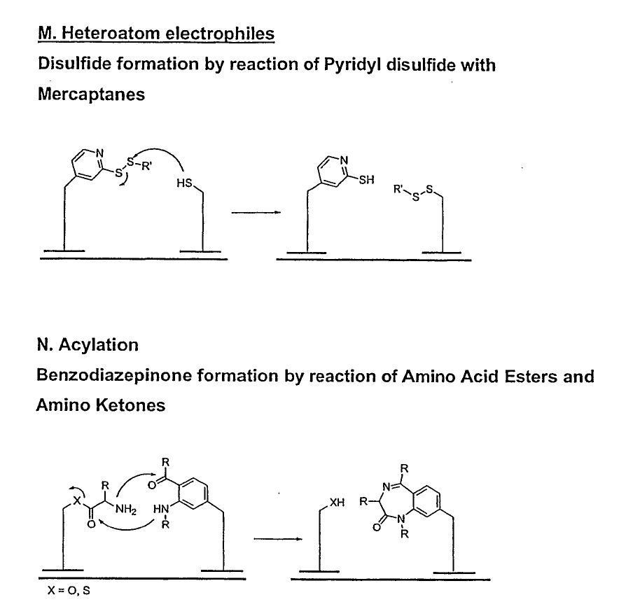

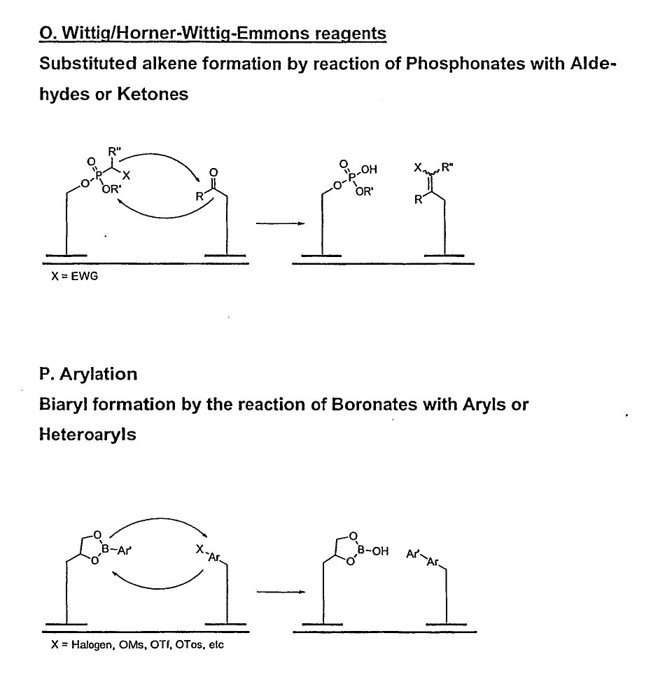

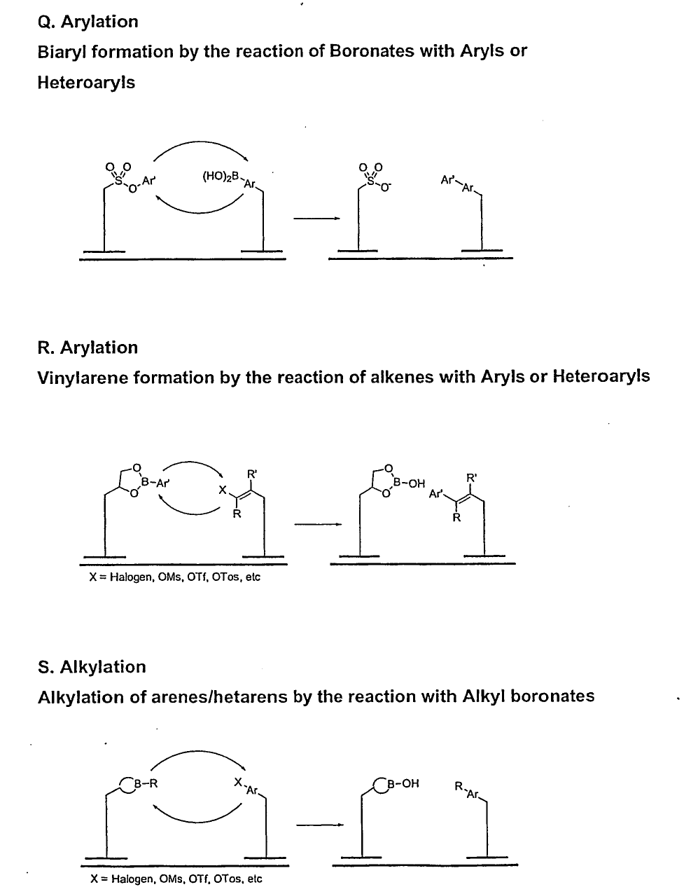

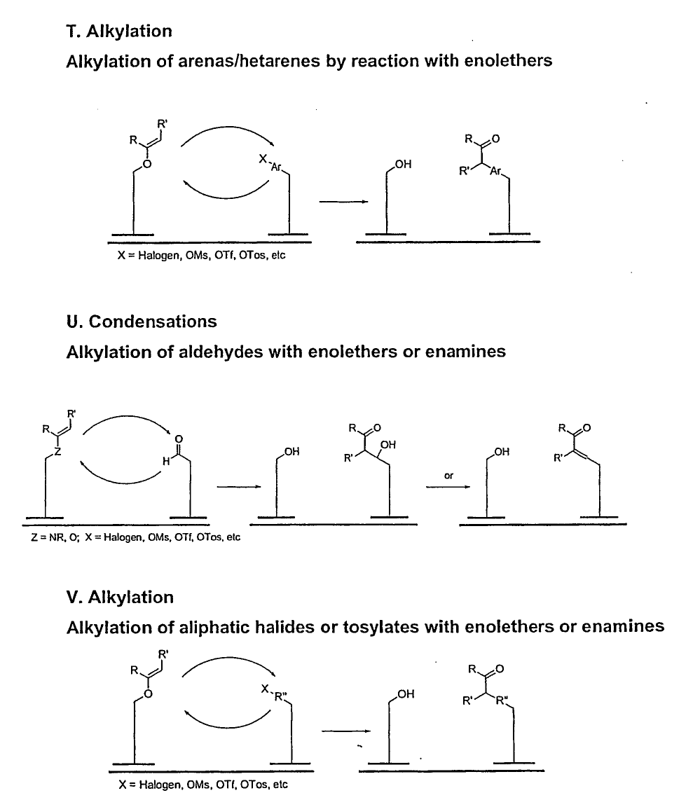

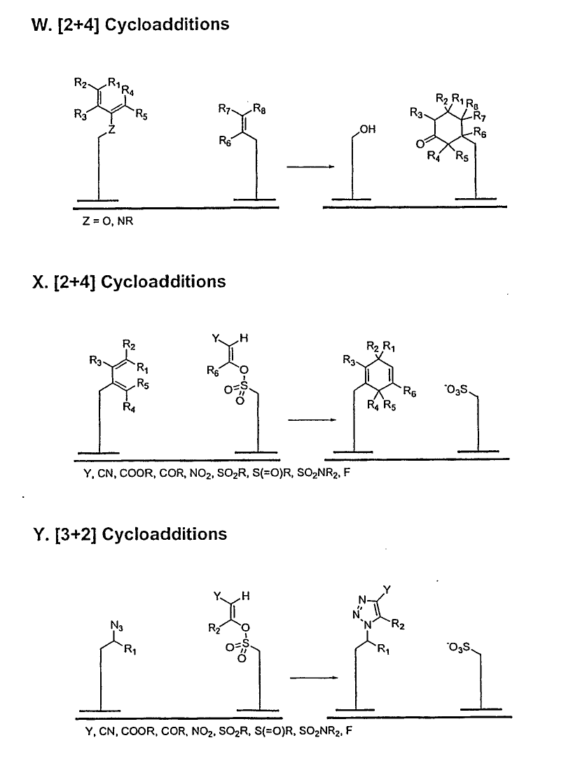

FIG. 4 shows different classes of reactions which mediate transfer of a chemical entity from a building block to another entity, or to an anchorage point. For simplicity reasons only, the receiving entity is shown as a building block; it is to be understood that the receiving entity can be covalently attached to the template as well. The reactions have been grouped into three different classes: Nucleophilic substitutions, addition-elimination reactions, and transition metal catalyzed reactions.
(A) Reaction of nucleophiles with carbonyls. As a result of the nucleophilic substitution, the functional group R is translocated to the monomer building block initially carrying the nucleophile.
(B) Nucleophilic attack by the amine on the thioester leads to formation of an amide bond, in effect translocating the functional group R of the thioester to the other monomer building block.
(C) Reaction between hydrazine and β-ketoester leads to formation of pyrazolone, in effect translocating the R and R′ functional groups to the other monomer building block.
(D) Reaction of hydroxylamine with β-ketoester leads to formation of the isoxazolone, thereby translocating the R and R′ groups to the other monomer building block.
(E) Reaction of thiourea with β-ketoester leads to formation of the pyrimidine, thereby translocating the R and R′ groups to the other monomer building block.
(F) Reaction of urea with malonate leads to formation of pyrimidine, thereby translocating the R group to the other monomer building block.
(G) Depending on whether Z=O or Z=NH, a Heck reaction followed by a nucleophilic substitution leads to formation of coumarin or quinolinon, thereby translocating the R and R′ groups to the other monomer building block.
(H) Reaction of hydrazine and phthalimides leads to formation of phthalhydrazide, thereby translocating the R and R′ groups to the other monomer building block.
(I) Reaction of amino acid esters leads to formation of diketopiperazine, thereby translocating the R group to the other monomer building block.
(J) Reaction of urea with α-substituted esters leads to formation of hydantoin, and translocation of the R and R′ groups to the other monomer building block.
(K) Alkylation may be achieved by reaction of various nucleophiles with sulfonates. This translocates the functional groups R and R′ to the other monomer building block.
(L) Reaction of a di-activated alkene containing an electron withdrawing and a leaving group, whereby the alkene is translocated to the nucleophile.
(M) Reaction of disulfide with mercaptane leads to formation of a disulfide, thereby transldcating the R′ group to the other monomer building block.
(N) Reaction of amino acid esters and amino ketones leads to formation of benzodiazepinone, thereby translocating the R group to the other monomer building block.
(O) Reaction of phosphonates with aldehydes or ketones leads to formation of substituted alkenes, thereby translocating the R″ group to the other monomer building block.
(P) Reaction of boronates with aryls or heteroaryls results in transfer of an aryl group to the other monomer building block (to form a biaryl).
(Q) Reaction arylsulfonates with boronates leads to transfer of the aryl group.
(R) Reaction of boronates with vinyls (or alkynes) results in transfer of an aryl group to the other monomer building block to form a vinylarene (or alkynylarene).
(S) Reaction between aliphatic boronates and arylhalides, whereby the alkyl group is translocated to yield an alkylarene.
(T) Transition metal catalysed alpha-alkylation through reaction between an enolether and an arylhallide, thereby translocating the aliphatic part.
(U) Condensations between e.g. enamines or enolethers with aldehydes leading to formation of alpha-hydroxy carbonyls or alpha, beta-unsaturated carbonyls. The reaction translocates the nucleophilic part.
(V) Alkylation of alkylhalides by e.g. enamines or enolethers. The reaction translocates the nucleophilic part.
(W) [2+4] cycloadditions, translocating the diene-part.
(X) [2+4] cycloadditions, translocating the ene-part.
(Y) [3+2] cycloadditions between azides and alkenes, leading to triazoles by translocation of the ene-part.
(Z) [3+2] cycloadditions between nitriloxides and alkenes, leading to isoxazoles by translocation of the ene-part.

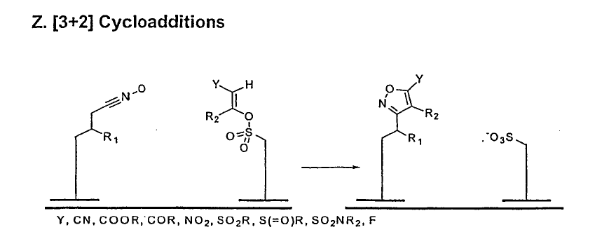

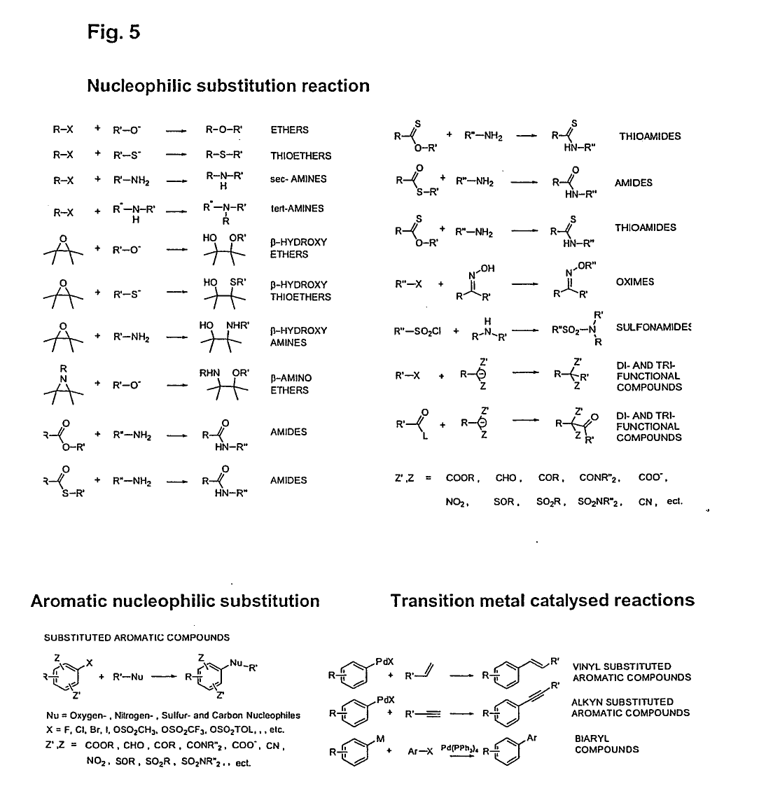

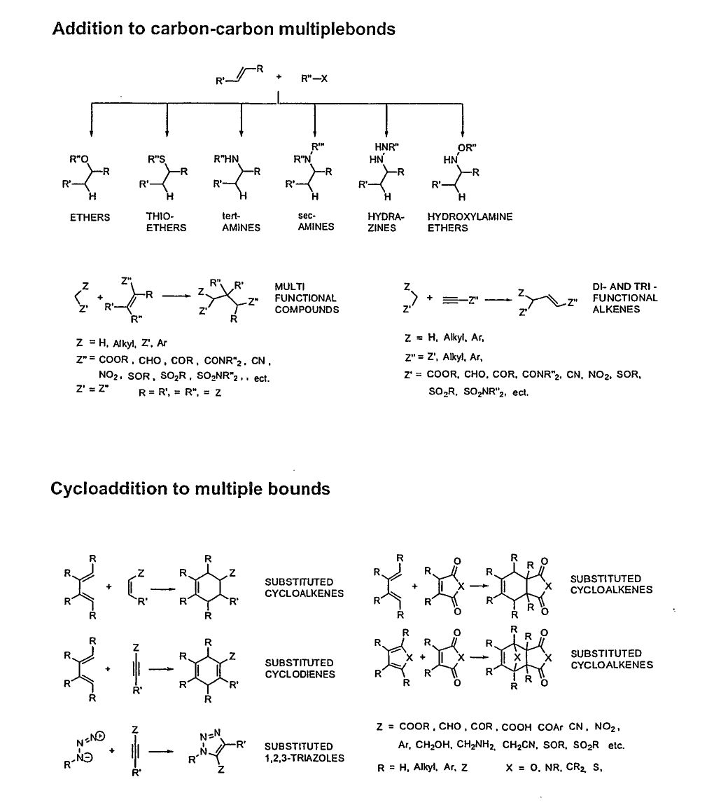

FIG. 5 shows collection of reactive groups that may be used for templated synthesis, along with the bonds formed upon their reaction. After reaction, activation (cleavage) may be required.

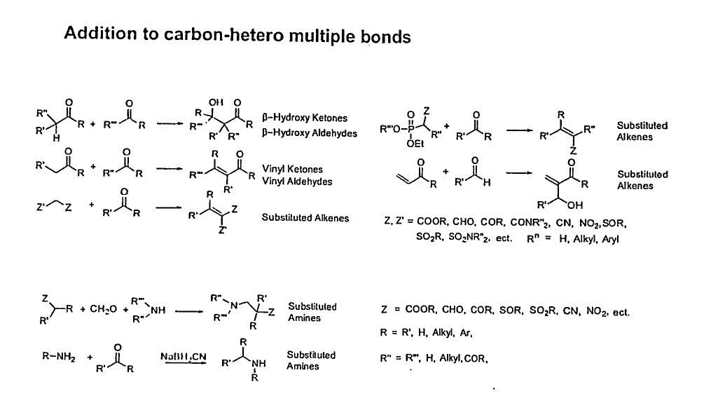

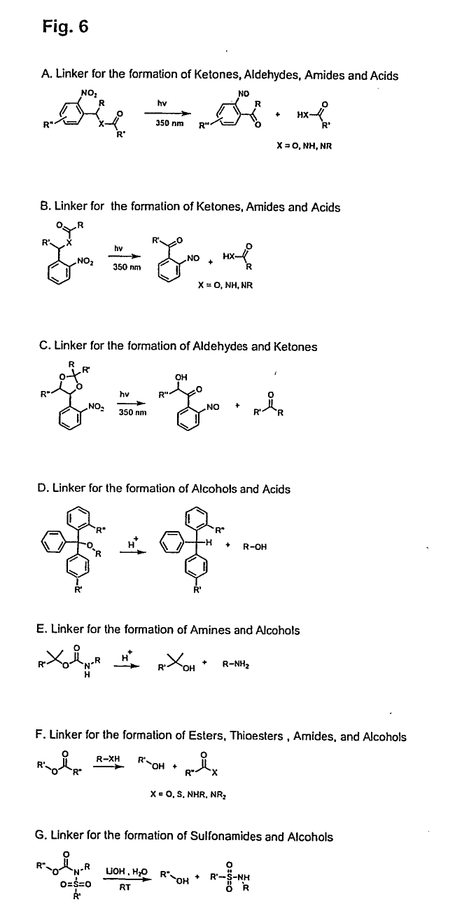

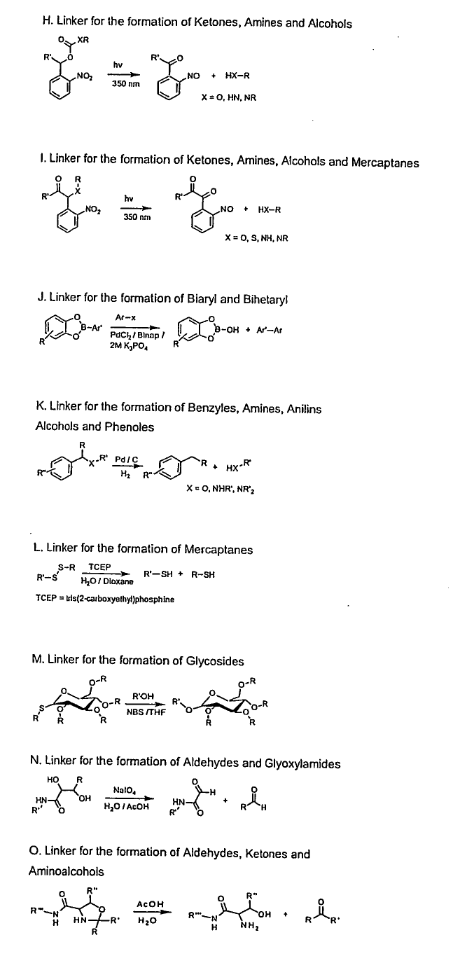

FIG. 6 shows various cleavable linkers, the conditions for their cleavage, and the resulting products.

### EXAMPLE

### Example 1. An encoded molecule libray of small molecules displayed on an array

This example describes how small molecules from an encoded library can be positioning on an array. These libraries are encoded by codons that codes for each chemical entity in the final displayed molecule. These codons describe the synthetic history which is directed by the template. This example will show how the codons can be used to positioning the displayed molecules on an array in a predetermining way trough the codon composition in each individual template molecule.

The example below shows the encoding process of a 27-membered library including the RGD (Arg-Gly-Asp) sequence. This tri-peptide sequence is known to bind to various integrins such as the α_{V}β₃ integrin, for example. The library has 27 different members because of the total amount of combinations possible for a tri-peptide (3³).

The scheme below shows the encoding of the RGD sequence as an example of all possible combination of these three different chemical entities. The annealing of the identifier (upper strand) to the building block (lower stand) allows the transfer of the chemical entities and their corresponding anti-codons to the nascent complex. The chemical entities are transferred by a chemical reaction and the information of the anti-codon are transferred to the nascent complex by extending the identifier using a polymerase and a mixture of dNTPs. The letters in bold indicate a flanking region of the anti-codon and the anticodon as well as the codon is underlined. I indicate the non-discriminating base inosine.

-GCA CAC TAG CTT GAG CAC AC
-D-CGT GTG ATC GAA CTC GTG TG GTATCCTGAGGGTAC

STEP 1B. Transfer of chemical entity D and anti-codon

-D-GCA CAC TAG CTT GAG CAC AC CATAGGACTCCCATG
-GCA CAC TAG CTT GAG CAC AC CATTCCTGAGGGTAC

STEP 2A. Annealing

-D-GCA CAC TAG CTT GAG CAC AC CATAGGACTCCCATG
-G-CGT GTG ATC GAA CTC GTG TG GTAIIIIIIIIITACGAAGC
TGTTACG

STEP 2B. Transfer of chemical entity G and anti-codon.

G-D-GCA CAC TAG CTT GAG CAC AC CATAGCACTCCCATGCTTC
GACAATGC
-CGT GTG ATC GAA CTC GTG TG GTAIIIIIIIIITACGAAG
CTGTTACG

STEP 3A. Annealing

-G-D-GCA CAC TAG CTT GAG CAC AC CATAGGACTCCCATGCTT
CGACAATGC
R-CGT GTG ATC GAA CTC GTG TG GTAIIIIIIIIITACIII
IIIIIIACGCCTCTAGTGCGT CGA AAT GCT AGG GCG

STEP 3B. Transfer of chemical entity D and anti-codon.

R-G-D-GCA CAC TAG CTT GAG CAC AC CATAGGACTCCCATGCT
TCGACAATGCGGAGATCACGCA GCT TTA CGA TCC CGC
-CGT GTG ATC GAA CTC GTG TG GTAIIIIIIIIITACII
IIIIIIIACGCCTCTAGTGCGT CGA AAT GCT AGG GCG

The transfer of chemical entities is described in detail below. This scheme shows in the first step how D is transferred from a building block to the identifier molecule and then how G and R is transfer from the building block to the scaffold (an amine group). The final step is a deprotection to obtain the RGD peptide linked to the template. The final product is a library complexes, wherein each complex comprises a template and an encoded tri-peptide.

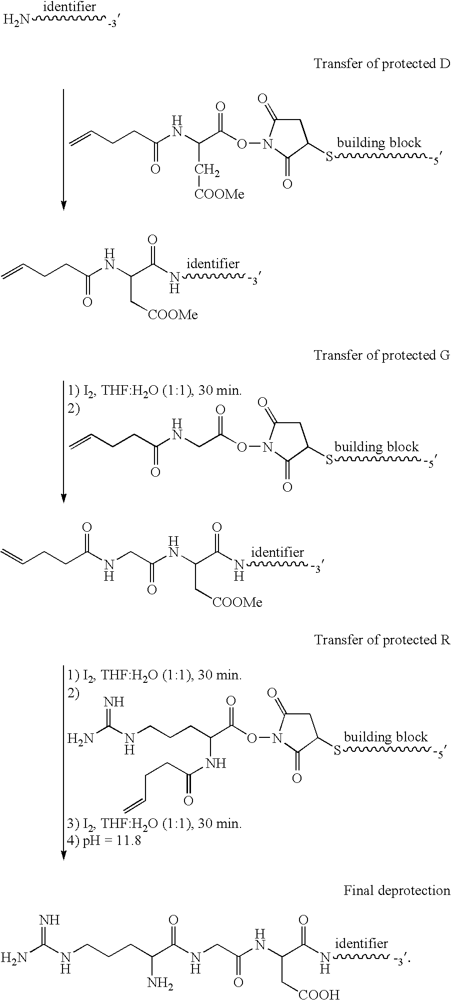

The small molecule binding setup. In this example, the array setup was tested in a regular ELISA assay to confirm the binding of integrin to the immobilized RGD-template molecule. The ELISA was performed by immobilizing the template molecules using biotin binding to immobilized streptavidin. The component involved in this setup is shown below. The binding of integrin to the immobilized RGD-template molecule was detected using a specific antibody.

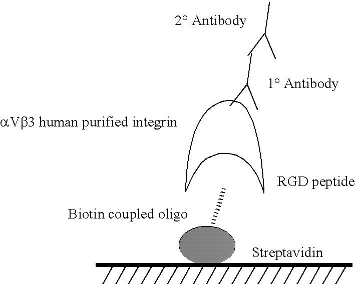

The result of the ELISA is shown below. The result shows that integrin binding is dependent of the immobilized RGD-template molecule. This setup with the immobilized RGD-template molecule is identical to the situation on the array except that the template molecule is immobilized through the probe that is complementary to the template molecule.

[image]

The ELISA was performed using a 20-mer 5′ biotinylated and 3′ cRGD peptide coupled oligos This construct were bound to precoated streptavidin 8 well strips (Pierce cat #15120) blocked over night in 0.5% Tween 20 (Sigma cat #P-9416), 3% casein (Sigma cat# C-8654) and 0.1 mg/ml herring sperm (Sigma cat# D-3159) in PBS. 3 pmol oligo/well diluted in 100 μl wash buffer (0.5% Tween 20, 3% casein in PBS) 1 hour shaking at r.t. After washing 5 times, block buffer was added and incubated another hour at r.t shaking. 0.1 μg/well α_{V}β₃ human purified integrin (Belkin V. M et al (1990) J.Cell boil. 111: 2159-2170) (Chemicon cat# CC1018) was added to each well in 100 μl wash buffer containing 1 mM MnCl₂ and incubated at room temperature shaking for 2 hours. After washing away unbound integrin, α_{V}β₃ integrin mouse monoclonal primary antibody (abcam cat # Ab7167) previously described (Martin-Padura I., et al (1995) J. Path. 175: 51) was added 0.05 μg/well in 100 μl wash buffer, incubated shaking at r.t for 1 hour. Followed by 10 washes and subsequently 2° polyclonal to mouse IgG horseradish peroxidase conjugated antibody (abcam cat# ab6728) incubation, 100 μl 1:2000 dilutions in wash-buffer, 1 hour shaking at r.t. After washing bound 2° antibody was detected by TMB plus substrate (Kem-En-Tech cat #4390L), 100 μl added and incubated until sufficient color development, to which 100 μl 0.2 M H₂SO₄ was added to stop the reaction. Absorbance was measured and recorded at 450 nm. Control used for the experiment was a none binding commonly used RAD peptide coupled to an oligo (J Control Release 2002 Oct. 4; 83(2):241-51).

Identification of encoded library members using arrays. GenFlex from Affymetrix is used to designing so called adaptor oligos which are complementary to the different probe oligos on the array. The adaptor oligos are also complementary to all the possible variations of codons on the identifier molecule as well as a flanking sequence showing the position of the codons. The figure below shows the outline of the setup with the adaptor oligo binding to both the identifier molecule as well as to the probe oligo on the array. This will display the molecule on the array determined by the codons in the template.

[image]

The generation of an encoded library gives a theoretical possibility of 27 different variants. To efficiently enable identification of all possible tripeptide variations generated by utilizing DNA array; codons were as described designed for which amino acid it is encoding. Flanking sequences of three nucleotides around every peptide codon was added to ensure the precise binding between the template and adaptor molecule.

In order to detect all possible variants in this RGD library, 27 different adaptor oligos has to be designed that recognizes each individual template molecule. These adaptor oligos will bind specifically to the probes on the array and therefore permit the binding of the template-displayed molecules. The adaptor oligos were designed to be complementary to probes on the GenFlex from Affymetrix. This chip contains 2000 different probes, of 20-mers bound to the chip. These 27 different adaptor oligos are shown below, where the bold letters is the complementary sequence to the various probes on the chip and the normal letter sequence is the part that corresponds to the codons and flanking sequences described above.

[image]

[image]

Adaptor oligos to be used for DNA array analysis for all RGD-library codon combinations (Marked in bold, complementary sequence to probe sequence with the probe set number on the chip to the right).

Primer# Sequence 5′-3′ Probe set # on chip

```
1. GCT AGG CTA ATG TCC GGC TAG TAG GAG ATCA CTA CGG AGA TCA CAC GGG AGA TCA CC GT
                            00109
2. AGG CAG ACA ACT CAA TCC GGG TAC TTC GAC AAT ACC TTC GAC AAA CGC TTC GAC AAC GT
                            00222
3. TCA GAC TAG GGT AGC GCA TAG TAA GGA CTC CCT ACA GGA CTC CCA CGA GGA CTC CCC GT
                            00348
4. TGT CCA GTA GCT TGA GAG TCG TAG GAG ATC ACT ACC TTC GAC AAA CGC TTC GAC AAC GT
                            00445
5. CGA CAA GGC ATT CAC ACT AGG TAG GAG ATC ACT ACG GAG ATC ACA CGC TTC GAC AAC GT
                            00470
6. TCG GCG TTA CGT GCT GAC TAG TAG GAG ATC ACT ACA GGA CTC CCA CGA GGA CTC CCC GT
                            00551
7. CCG CAG CAA GCT ATC GAG AAG TAG GAG ATC ACT ACG GAG ATC ACA CGA GGA CTC CCC GT
                            00694
8. CGA AAG CAT AAT AGC GGT GCG TAC TTC GAC AAT ACG GCG ATC ACA CGA GGA CTC CCC GT
                            00729
9. GTA CGT TGA CAG TCT GCA CAG TAC TTC GAC AAT ACG GAG ATC ACA CGG GAG ATC ACC GT
                            00852
10. GTC TGG CCC TAC CTA TGG TTG TAC TTC GAC AAT ACC TTC GAC AAA CGG GAG ATC ACC GT
                            00891
11. ACC AAT GCA AAT AGG CGG CCG TAA GGA CTC CCT ACC TTC GAC AAA CGG GAG ATC ACC GT
                            00922
12. TCA GGC CCA CGT AGC GTT ATG TAA GGA CTC CCT ACG GAG ATC ACA CGG GAG ATC ACC GT
                            01033
13. GAA CTA TGC TGA CAG TAC CGG TAC TTC GAC AAT ACA GGA CTC CCA CGG GAG ATC ACC GT
                            01081
14. CCC AGG GCA AGC GAT CAT AAG TAC TTC GAC AAT ACA GGA CTC CCA CGA GGA CTC CCC GT
                            01109
15. TCA CGT AAT TTG TTA GCC GCG TAC TTC GAC AAT ACC TTC GAC AAA CGA GGA CTC CCC GT
                            01187
16. TAC CTG GCA TGA CGC GAT ATG TAA GGA CTC CCT ACC TTC GAC AAA CGA GGA CTC CCC GT
                            01360
17. TGC AGG CTC GCA GAT GCT ATG TAA GGA CTC CCT ACA GGA CTC CCA CGC TTC GAC AAC GT
                            01414
18. TGA GCG TTA GAG CTT GAT CCG TAG GAG ATC ACT ACC TTC GAC AAA CGA GGA CTC CCC GT
                            01522
19. TCT CGG TTA CTG AGT GGA CTG TAA GGA CTC CCT ACC TTC GAC AAA CGG GAG ATC ACC GT
                            01526
20. CGA CGA GCA CCA ATT CGA GAG TAA GGA CTC CCT ACC TTC GAC AAA CGC TTC GAC AAC GT
                            01548
21. GTT AGA TCA TAG TCA CCG CGG TAA GGA CTC CCT ACA GGA CGC CCA CGG GAG ATC ACC GT
                            01610
22. CAC TAA GAC ATG CAC AGC GGG TAG GAG ATC ACT ACA GGA CTC CCA CGC TTC GAC AAC GT
                            01715
23. CTA CTG ACA CTG ACC AGG GAG TAC TTC GAC AAT ACG GAG ATC ACA CGC TTC GAC AAC GT
                            01800
24. GCA TAC AGG TTA CGA CGC CTG TAG GAG ATC ACT ACC TTC GAC AAA CGG GAG ATC ACC GT
                            01882
25. CTT CGC GCA GCT ACA TAG ATG TAA GGA CTC CCT ACG GAG ATC ACA CGA GGA CTC CCC GT
                            01928
26. GGC ATA CTA GAG TCA GCG ATG TAC TTC GAC AAT ACA GGA CTC CCA CGC TTC GAC AAC GT
                            01955
27. ATC AAG GCA ACC GCC AGT AGG TAG GAC ATC ACT ACA GGA CTC CCA CGG GAG ATC ACC GT
                            01991
```

The adaptor oligos and the templates with displayed molecules were used for analysis on GenFlex according to protocol below.

GenFlex hybridisation and scanning. Prior to hybridization, the Adaptor mix (100 pM each final concentration) in a hybridization buffer (100 mM MES, 1 M NaCl, 20 mM EDTA, 0.01% Tween 20, 1×Denhardt's), was heated to 95° C. for 5 min and subsequently to 40° C. for 5 min before loading onto the Affymetrix GenFlex probe array cartridge. The probe array was then incubated for 2 h at 45° C. at constant rotation (60 rpm). The Adaptor mix was removed from the GenFlex cartridge, and replaced with the Template in a hybridization buffer (100 mM MES, 1 M NaCl, 20 mM EDTA, 0.01% Tween 20, 1×Denhardt's). The Template hybridisation mix was heated to 95° C. for 5 min and subsequently to 40° C. for 5 min before loading onto the Affymetrix GenFlex probe array cartridge and hybridised for 2 h at 45° C. at constant rotation (60 rpm). The washing and staining procedure was performed in the Affymetrix Fluidics Station. The probe array was exposed to 2 wash in 6×SSPE-T at 25° C. followed by 12 washes in 0.5×SSPE-T at 40° C. Then, 0.1 μg/well α_{V}β₃ human purified integrin (Belkin V. M et al (1990) J. Cell boil. 111: 2159-2170) (Chemicon cat # CC1018) was added to the chip in wash buffer containing 1 mM MnCl₂ and incubated at room temperature shaking for 2 hours. After washing away unbound integrin, α_{V}β₃ integrin mouse monoclonal primary antibody (abcam cat # Ab7167) previously described (Martin-Padura I., et al (1995) J. Path. 175: 51) was added in wash buffer, and rotated at room temperature for 1 hour. Then, after 5-10 washes a 2° polyclonal to mouse IgG horseradish peroxidase conjugated antibody (abcam cat # ab6728) was incubation in the washbuffer. After washing off non-bound 2° antibody the probe arrays were scanned at 560 nm using a confocal laser-scanning microscope with an argon ion laser as the excitation source (Hewlett Packard GeneArray Scanner G2500A).

1. A microarray comprising a plurality of single stranded nucleic acid probes immobilized in discrete areas of a solid support, said probes being hybridised to a library of complexes, wherein each complex comprises an encoded molecule and a template which codes for said molecule, said template comprising a number of codons which codes for chemical entities which upon reaction form a reaction product which at least partly form part of the encoded molecule.

2. a microarray according to claim 1, wherein the chemical entities are precursors for a structural unit appearing in the encoded molecule.

3. A microarray according to claim 1, wherein the chemical entities are transferred to the nascent encoded molecule by a building block, which further comprises an anti-codon.

4. A microarray according to claim 3, wherein the information of the anti-codon is transferred in conjunction with the chemical entity to the nascent complex.

5. A microarray according to claim 1, wherein the chemical entities are reacted without enzymatic interaction.

6. A microarray according to claim 1, wherein the template comprises two or more codons.

7. A microarray according to claim 1, wherein the nucleic acid probe of the array is hybridised to a template through an adapter oligonucleotide having a sequence complementing the probe as well as the template.

8. A method for preparing a microarray displaying a library of encoded molecules, wherein an oligonucleotide microarray comprising a plurality of single stranded nucleic acid probes immobilized in discrete areas of a solid support is mixed under conditions which allows for specific hybridisation with a library of complexes, each of said complexes comprising an encoded molecule and a template which codes for said molecule, said template comprising a number of codons which codes for chemical entities which upon reaction form a reaction product which at least partly form part of the encoded molecule.

9. A method for identifying an encoded molecule having a preselected property, comprising the steps of
i) providing the microarray according to claim 1
ii) adding a biological sample containing target molecules,
iii) washing non-bound material off, and
iv) detecting any bound material in each spot.

10. (canceled)

11. A microarray according to claim 2, wherein the chemical entities are transferred to the nascent encoded molecule by a building block, which further comprises an anti-codon.

12. A microarray according to claim 11, wherein the information of the anti-codon is transferred in conjunction with the chemical entity to the nascent complex.

13. A microarray according to claim 2, wherein the chemical entities are reacted without enzymatic interaction.

14. A microarray according to claim 2, wherein the template comprises two or more codons.

15. A microarray according to claim 2, wherein the nucleic acid probe of the array is hybridised to a template through an adapter oligonucleotide having a sequence complementing the probe as well as the template.

16. A microarray according to claim 11, wherein the chemical entities are reacted without enzymatic interaction.

17. A microarray according to claim 11, wherein the template comprises two or more codons.

18. A microarray according to claim 11, wherein the nucleic acid probe of the array is hybridised to a template through an adapter oligonucleotide having a sequence complementing the probe as well as the template.

19. A microarray according to claim 3, wherein the chemical entities are reacted without enzymatic interaction.

20. A microarray according to claim 3, wherein the template comprises two or more codons.

21. A microarray according to claim 3, wherein the nucleic acid probe of the array is hybridised to a template through an adapter oligonucleotide having a sequence complementing the probe as well as the template.


SEQUENCE LISTING (69 sequences)

SEQ ID NO: 1 - DNA, 20 bp, Artificial
  Synthetic
gcacactagcttgagcacac

SEQ ID NO: 2 - DNA, 35 bp, Artificial
  Synthetic
catgggagtcctatggtgtgctcaagctagtgtgn

SEQ ID NO: 3 - DNA, 35 bp, Artificial
  Synthetic
ncacactagcttgagcacaccataggactcccatg

SEQ ID NO: 4 - DNA, 35 bp, Artificial
  Synthetic
catgggagtccttaccacacgagttcgatcacacg

SEQ ID NO: 5 - DNA, 35 bp, Artificial; identical to SEQ ID NO: 3
  Synthetic

SEQ ID NO: 6 - DNA, 47 bp, Artificial
  Synthetic
gcattgtcgaagcatnnnnnnnnnatggtgtgctcaagctagtgtgn

SEQ ID NO: 7 - DNA, 47 bp, Artificial
  Synthetic
ncacactagcttgagcacaccataggactcccatgcttcgacaatgc

SEQ ID NO: 8 - DNA, 47 bp, Artificial
  Synthetic
gcattgtcgaagcatnnnnnnnnnatggtgtgctcaagctagtgtgc

SEQ ID NO: 9 - DNA, 47 bp, Artificial; identical to SEQ ID NO: 7
  Synthetic

SEQ ID NO: 10 - DNA, 74 bp, Artificial
  Synthetic
gcgggatcgtaaagctgcgtgatctccgcannnnnnnnncatnnnnnnnnnatggtgtgctcaagctagtgtgn

SEQ ID NO: 11 - DNA, 74 bp, Artificial
  Synthetic
ncacactagcttgagcacaccataggactcccatgcttcgacaatgcggagatcacgcagctttacgatcccgc

SEQ ID NO: 12 - DNA, 74 bp, Artificial
  Synthetic
gcgggatcgtaaagctgcgtgatctccgcannnnnnnnncatnnnnnnnnnatggtgtgctcaagctagtgtgc

SEQ ID NO: 13 - DNA, 9 bp, Artificial
  Synthetic
nctctagtg

SEQ ID NO: 14 - DNA, 9 bp, Artificial
  Synthetic
naagctgtt

SEQ ID NO: 15 - DNA, 9 bp, Artificial
  Synthetic
ncctgaggg

SEQ ID NO: 16 - DNA, 39 bp, Artificial
  Synthetic
catcctctagtgatgcctctagtgtgccctctagtggca

SEQ ID NO: 17 - DNA, 39 bp, Artificial
  Synthetic
catgaagctgttatggaagctgtttgcgaagctgttgca

SEQ ID NO: 18 - DNA, 39 bp, Artificial
  Synthetic
cattcctgagggatgtcctgagggtgctcctgaggggca

SEQ ID NO: 19 - DNA, 39 bp, Artificial
  Synthetic
catcctctagtgatggaagctgtttgcgaagctgttgca

SEQ ID NO: 20 - DNA, 39 bp, Artificial
  Synthetic
catcctctagtgatgcctctagtgtgcgaagctgttgca

SEQ ID NO: 21 - DNA, 39 bp, Artificial
  Synthetic
catcctctagtgatgtcctgagggtgctcctgaggggca

SEQ ID NO: 22 - DNA, 39 bp, Artificial
  Synthetic
catcctctagtgatgcctctagtgtgctcctgaggggca

SEQ ID NO: 23 - DNA, 39 bp, Artificial
  Synthetic
catgaagctgttatgcctctagtgtgctcctgaggggca

SEQ ID NO: 24 - DNA, 39 bp, Artificial
  Synthetic
catgaagctgttatgcctctagtgtgccctctagtggca

SEQ ID NO: 25 - DNA, 39 bp, Artificial
  Synthetic
catgaagctgttatggaagctgtttgccctctagtggca

SEQ ID NO: 26 - DNA, 39 bp, Artificial
  Synthetic
cattcctgagggatggaagctgtttgccctctagtggca

SEQ ID NO: 27 - DNA, 39 bp, Artificial
  Synthetic
cattcctgagggatgcctctagtgtgccctctagtggca

SEQ ID NO: 28 - DNA, 39 bp, Artificial
  Synthetic
catgaagctgttatgtcctgagggtgccctctagtggca

SEQ ID NO: 29 - DNA, 39 bp, Artificial
  Synthetic
catgaagctgttatgtcctgagggtgctcctgaggggca

SEQ ID NO: 30 - DNA, 39 bp, Artificial
  Synthetic
catgaagctgttatggaagctgtttgctcctgaggggca

SEQ ID NO: 31 - DNA, 39 bp, Artificial
  Synthetic
cattcctgagggatggaagctgtttgctcctgaggggca

SEQ ID NO: 32 - DNA, 39 bp, Artificial
  Synthetic
cattcctgagggatgtcctgagggtgcgaagctgttgca

SEQ ID NO: 33 - DNA, 39 bp, Artificial
  Synthetic
catcctctagtgatggaagctgtttgctcctgaggggca

SEQ ID NO: 34 - DNA, 39 bp, Artificial; identical to SEQ ID NO: 26
  Synthetic

SEQ ID NO: 35 - DNA, 39 bp, Artificial
  Synthetic
cattcctgagggatggaagctgtttgcgaagctgttgca

SEQ ID NO: 36 - DNA, 39 bp, Artificial
  Synthetic
cattcctgagggatgtcctgagggtgccctctagtggca

SEQ ID NO: 37 - DNA, 39 bp, Artificial
  Synthetic
catcctctagtgatgtcctgagggtgcgaagctgttgca

SEQ ID NO: 38 - DNA, 39 bp, Artificial
  Synthetic
catgaagctgttatgcctctagtgtgcgaagctgttgca

SEQ ID NO: 39 - DNA, 39 bp, Artificial
  Synthetic
catcctctagtgatggaagctgtttgccctctagtggca

SEQ ID NO: 40 - DNA, 39 bp, Artificial
  Synthetic
cattcctgagggatgcctctagtgtgctcctgaggggca

SEQ ID NO: 41 - DNA, 39 bp, Artificial
  Synthetic
catgaagctgttatgtcctgagggtgcgaagctgttgca

SEQ ID NO: 42 - DNA, 39 bp, Artificial
  Synthetic
catcctctagtgatgtcctgagggtgccctctagtggca

SEQ ID NO: 43 - DNA, 59 bp, Artificial
  Synthetic
gctaggctaatgtccggctagtaggagatcactacggagatcacacgggagatcaccgt

SEQ ID NO: 44 - DNA, 59 bp, Artificial
  Synthetic
aggcagacaactcaatccgggtacttcgacaataccttcgacaaacgcttcgacaacgt

SEQ ID NO: 45 - DNA, 59 bp, Artificial
  Synthetic
tcagactagggtagcgcatagtaaggactccctacaggactcccacgaggactccccgt

SEQ ID NO: 46 - DNA, 59 bp, Artificial
  Synthetic
tgtccagtagcttgagagtcgtaggagatcactaccttcgacaaacgcttcgacaacgt

SEQ ID NO: 47 - DNA, 59 bp, Artificial
  Synthetic
cgacaaggcattcacactaggtaggagatcactacggagatcacacgcttcgacaacgt

SEQ ID NO: 48 - DNA, 59 bp, Artificial
  Synthetic
tcggcgttacgtgctgactagtaggagatcactacaggactcccacgaggactccccgt

SEQ ID NO: 49 - DNA, 59 bp, Artificial
  Synthetic
ccgcagcaagctatcgagaagtaggagatcactacggagatcacacgaggactccccgt

SEQ ID NO: 50 - DNA, 59 bp, Artificial
  Synthetic
cgaaagcataatagcggtgcgtacttcgacaatacggcgatcacacgaggactccccgt

SEQ ID NO: 51 - DNA, 59 bp, Artificial
  Synthetic
gtacgttgacagtctgcacagtacttcgacaatacggagatcacacgggagatcaccgt

SEQ ID NO: 52 - DNA, 59 bp, Artificial
  Synthetic
gtctggccctacctatggttgtacttcgacaataccttcgacaaacgggagatcaccgt

SEQ ID NO: 53 - DNA, 59 bp, Artificial
  Synthetic
accaatgcaaataggcggccgtaaggactccctaccttcgacaaacgggagatcaccgt

SEQ ID NO: 54 - DNA, 59 bp, Artificial
  Synthetic
tcaggcccacgtagcgttatgtaaggactccctacggagatcacacgggagatcaccgt

SEQ ID NO: 55 - DNA, 59 bp, Artificial
  Synthetic
gaactatgctgacagtaccggtacttcgacaatacaggactcccacgggagatcaccgt

SEQ ID NO: 56 - DNA, 59 bp, Artificial
  Synthetic
cccagggcaagcgatcataagtacttcgacaatacaggactcccacgaggactccccgt

SEQ ID NO: 57 - DNA, 59 bp, Artificial
  Synthetic
tcacgtaatttgttagccgcgtacttcgacaataccttcgacaaacgaggactccccgt

SEQ ID NO: 58 - DNA, 59 bp, Artificial
  Synthetic
tacctggcatgacgcgatatgtaaggactccctaccttcgacaaacgaggactccccgt

SEQ ID NO: 59 - DNA, 59 bp, Artificial
  Synthetic
tgcaggctcgcagatgctatgtaaggactccctacaggactcccacgcttcgacaacgt

SEQ ID NO: 60 - DNA, 59 bp, Artificial
  Synthetic
tgagcgttagagcttgatccgtaggagatcactaccttcgacaaacgaggactccccgt

SEQ ID NO: 61 - DNA, 59 bp, Artificial
  Synthetic
tctcggttactgagtggactgtaaggactccctaccttcgacaaacgggagatcaccgt

SEQ ID NO: 62 - DNA, 59 bp, Artificial
  Synthetic
cgacgagcaccaattcgagagtaaggactccctaccttcgacaaacgcttcgacaacgt

SEQ ID NO: 63 - DNA, 59 bp, Artificial
  Synthetic
gttagatcatagtcaccgcggtaaggactccctacaggacgcccacgggagatcaccgt

SEQ ID NO: 64 - DNA, 59 bp, Artificial
  Synthetic
cactaagacatgcacagcgggtaggagatcactacaggactcccacgcttcgacaacgt

SEQ ID NO: 65 - DNA, 59 bp, Artificial
  Synthetic
ctactgacactgaccagggagtacttcgacaatacggagatcacacgcttcgacaacgt

SEQ ID NO: 66 - DNA, 59 bp, Artificial
  Synthetic
gcatacaggttacgacgcctgtaggagatcactaccttcgacaaacgggagatcaccgt

SEQ ID NO: 67 - DNA, 59 bp, Artificial
  Synthetic
cttcgcgcagctacatagatgtaaggactccctacggagatcacacgaggactccccgt

SEQ ID NO: 68 - DNA, 59 bp, Artificial
  Synthetic
ggcatactagagtcagcgatgtacttcgacaatacaggactcccacgcttcgacaacgt

SEQ ID NO: 69 - DNA, 59 bp, Artificial
  Synthetic
atcaaggcaaccgccagtaggtaggacatcactacaggactcccacgggagatcaccgt